(19) United States
(12) Patent Application Publication
(10) Pub. No.: US 2013/0139065 A1
(43) Pub. Date: May 30, 2013

(54) Employee information mobile application

(71) Applicant: Troy Spinks, Washington, NJ (US)

(72) Inventor: Troy Spinks, Washington, NJ (US)

(21) Appl. No.: 13/373,699

(22) Filed: Nov. 28, 2011

(51) Int. Cl. G06F 3/01

(52) U.S. Cl. 715/743

(57) ABSTRACT

An application software designed to run on the popular mobile operating systems can be used by employees of a business to exchange messages with other employees, schedule work time and time-off and trade work days or work shift assignments. The mobile application allows efficient employee interaction with minimal intervention by management.

### BACKGROUND OF THE INVENTION

The present invention relates to the field of application software, and more particularly to mobile applications used in connection with employee information.

The present invention is application software designed to run on the popular mobile operating systems, such as iOS or Android. The “app” is to be primarily sold to retail businesses, .such as “brick and mortar” stores, where employees must be present and have fluctuating schedules. The app would be provided by the employer to its employees, who could download it onto their mobile phones/devices. The app would have a password-protected secure sign-in, based on existing user names and passwords, followed by a main menu from which the employee could view their work schedule, schedule time off/vacation, trade shift assignments, and view messages. Optionally, the app could also provide access to some of the employee's personnel information, such as retirement savings, benefits, and sick/personal time, if the purchaser requests it.

As reflected in the patent literature, the employee mobile applications that have been developed to date primarily relate to three types of functions: (1) work flow and task management, (2) payroll and time sheet management, and (3) resource/equipment management.

In the first category are the patent applications of Costello (U.S. 2005/0021428), Hamilton et al. (U.S. 2008/0059267), and Gala (U.S. 2010/0312606). Costello teaches a relatively primitive application for transmitting remote employee time transaction data. The Hamilton system involves task progress reporting based on incremental completion levels. The Gala system is directed toward some elements of scheduling, such as overtime, break time, etc. But the purpose of the Gala system is primarily for use by management in sending alerts and notices to employees, whereas the system used in the present invention involves little or no management involvement. The present invention is primarily directed toward the employee, whereas the Gala system is primarily for use by management staff.

In the second category is the patent application of Saiu et al. (U.S. 2011/0191217), which is also management-oriented application software, providing for submission and approval of time sheets, progress logs, and expense reports. The patent applications of Nessland et al. (U.S. 2008/0313005) and Erhart et al. (U.S. 2010/0153171) are also management-oriented application software, primarily used to control employee access to business resources, such as laptop computers and company vehicles.

The present invention differs from the prior art insofar as it implements an employee-centered information system which requires minimal interaction and oversight by management. Instead of offering a clock-in option, the present invention provides for minimal employee editability, but mainly information viewing options. The prior art contains no suggestions of combining elements of the various management-oriented apps to arrive at an employee-oriented system. As a matter of fact, the teachings of the prior art run contrary to such an innovation.

### SUMMARY OF THE INVENTION

The employee information mobile application is an app developed for mobile operating systems, such as iOS and Android. This application allows an employee of the company that the application is developed for to easily view their schedule and make simple changes to it. The application would work off an employer's pre-existent scheduling tool using existing employee numbers and passwords. For security reasons, the application would be made to be very simple, and every time the application is exited the employee would be logged out. There are no manager versions of the application, because that would offer too much editability.

The purchasers of the application would not be employees themselves, but companies that want the application developed for use by their employees. If an application is developed for a company, then the company would have the option to make changes to the application. These changes include the option to change permanent availability, create/reply to messages, etc. In addition to changes, the application would also be branded with the company logo and colors.

The source application can single-handedly support an entire application studio. The reason for this is that once the basic application is created, the studio simply needs to re-package it for the company that purchases it, while keeping a large majority of the initial coding. Since the application would be sold to companies and not employees, there is an extremely large number of businesses that this could be sold to, and long term contracts could be made for updates, changes, etc.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a flow chart showing the interaction of the pages of the preferred embodiment of the employee information mobile application.

FIG. 2 is the Login Page of the preferred embodiment of the employee information mobile application.

FIG. 3 is the Main Page of the preferred embodiment of the employee information mobile application.

FIG. 4 is the Message Page of the preferred embodiment of the employee information mobile application.

FIG. 5 is the Schedule Page of the preferred embodiment of the employee information mobile application.

FIG. 6 is the Time-Off Page of the preferred embodiment of the employee information mobile application.

FIG. 7 is the Trades Page of the preferred embodiment of the employee information mobile application.

### DETAILED DESCRIPTION OF THE PREFERRED EMBODIMENT

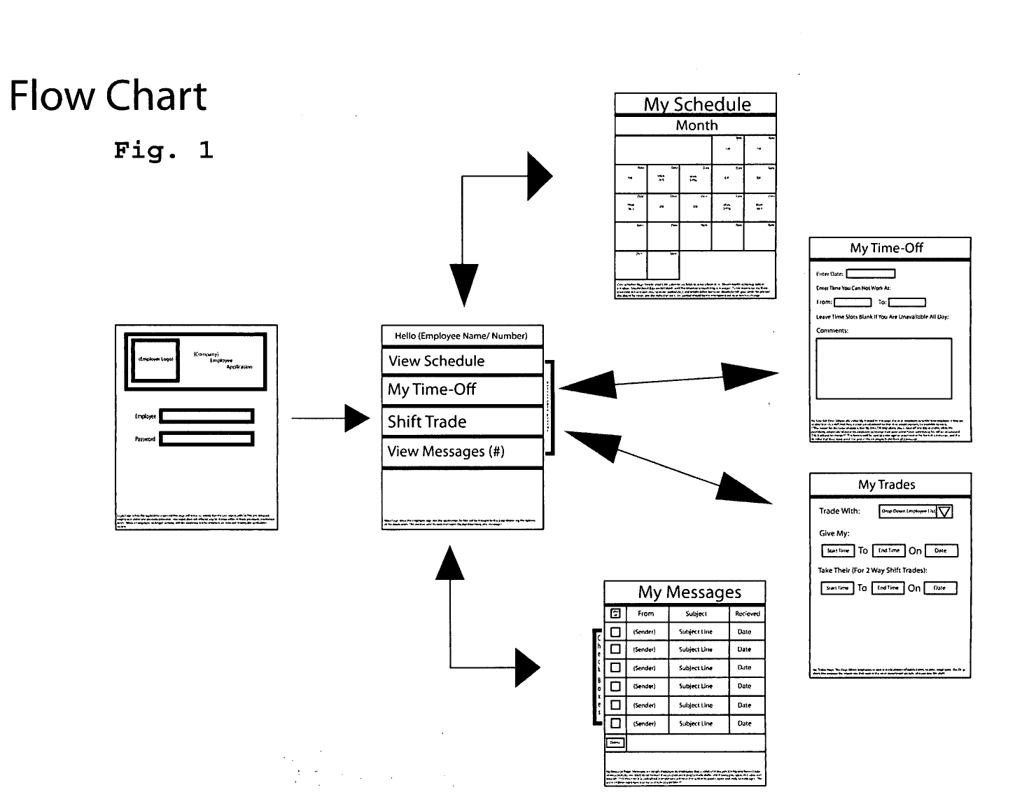

Referring to FIG. 1, this is an exemplary flow chart of the basic pages in the application. The first page can only go forward because the employee is logged out automatically when the application closes.

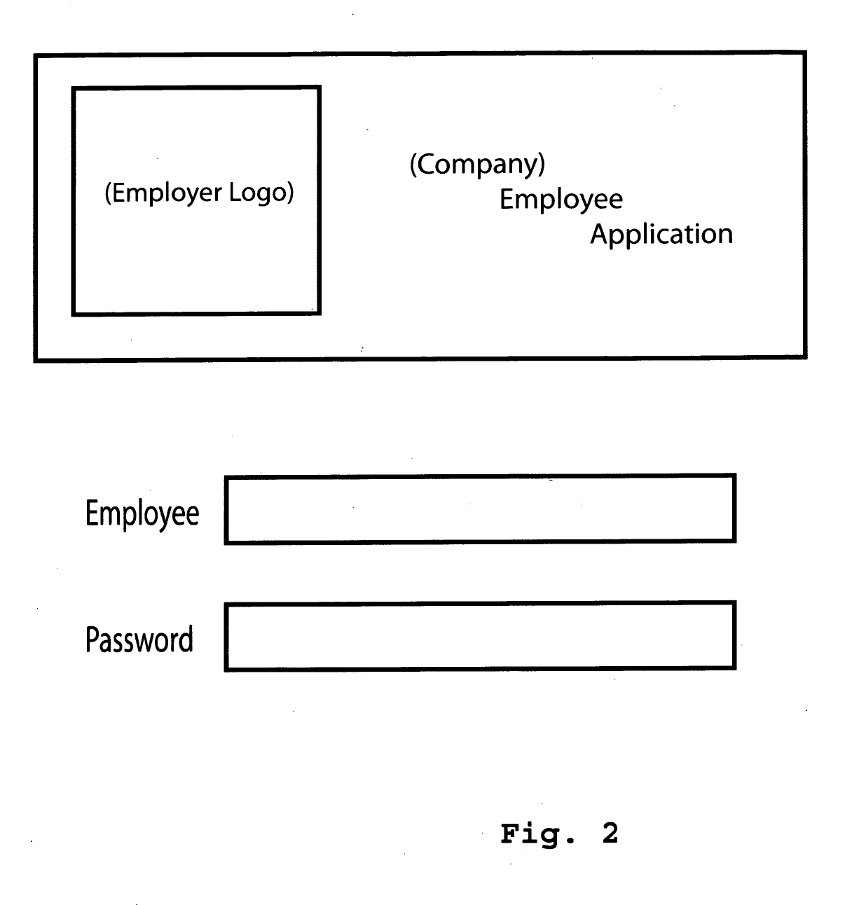

Referring to FIG. 2, this depicts the Login Page. When the application is opened, this page will come up asking that the user sign in with his/her pre-assigned employee number and pre-selected password. This application will offer no way to change either of those previously mentioned fields. When an employee is no longer working with the employer, his/her employee number is de-activated, leaving the application inoperable.

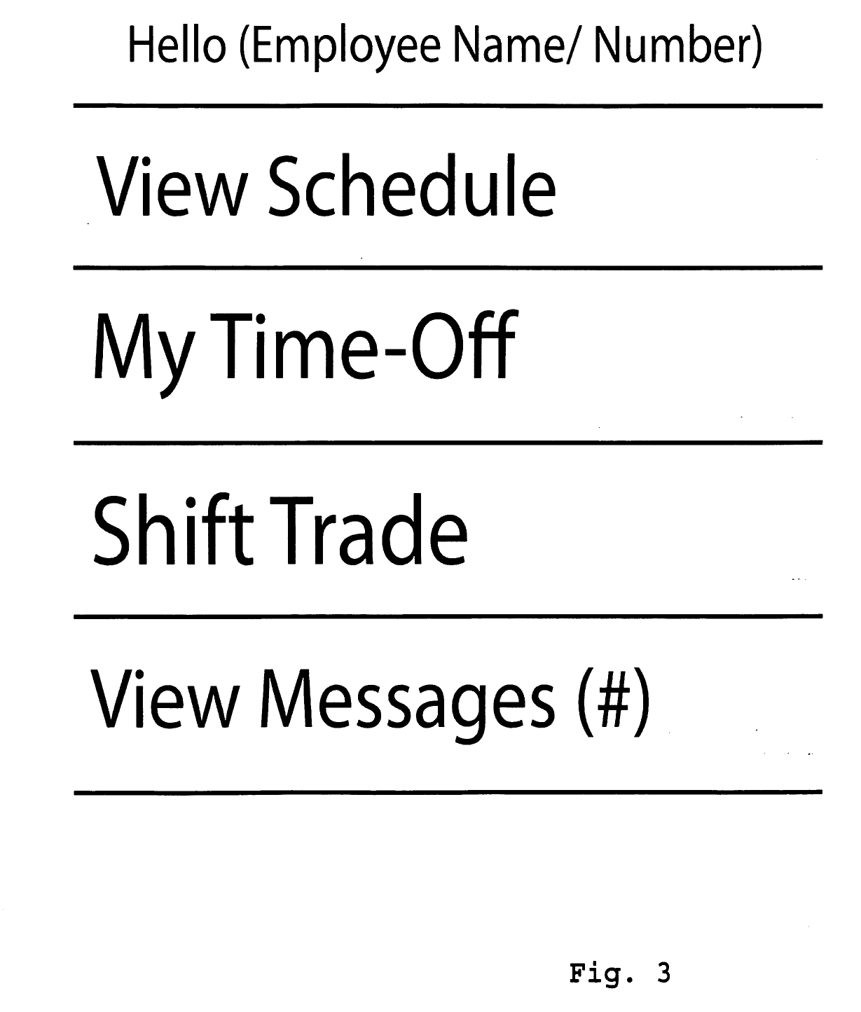

Referring to FIG. 3, this depicts the Main Page. Once the employee logs into the application, he/she will be brought to this page displaying the options of the application. The number next to “view messages” displays how many new messages the employee has.

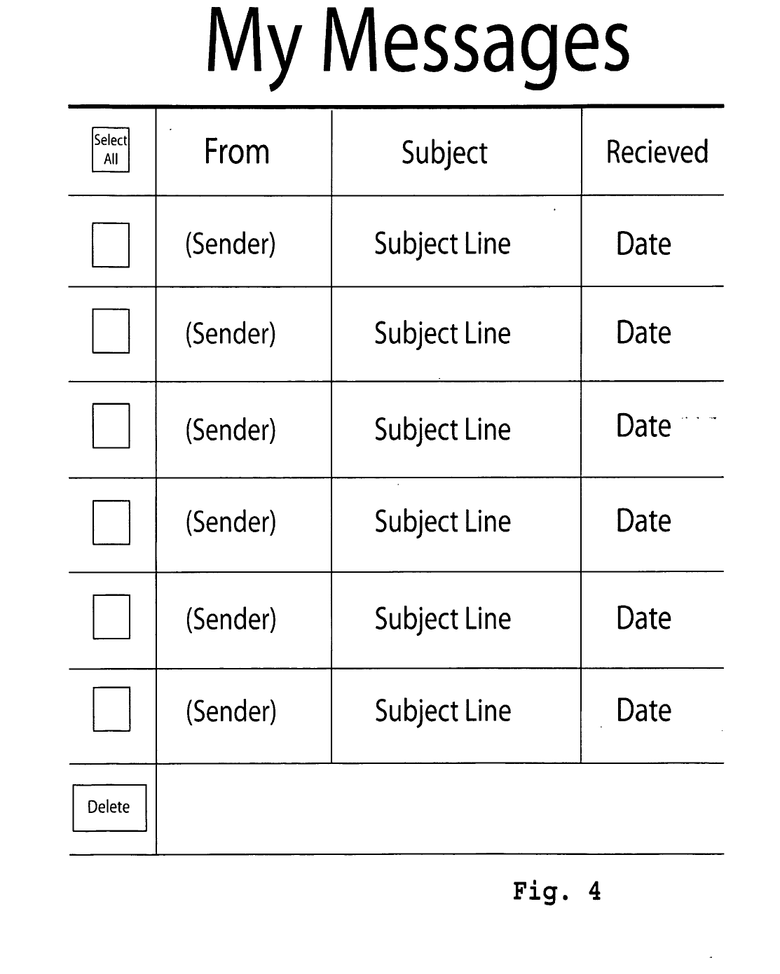

Referring to FIG. 4, this depicts the Message Page. The “My Messages” are simple messages to employees that may let employees know when their schedules are ready to be viewed, or if other employees are proposing to trade shifts, or if managers approve trades and time off. Employess may have the option to create, open and reply to messages. The point of these messages is to be as simple as possible.

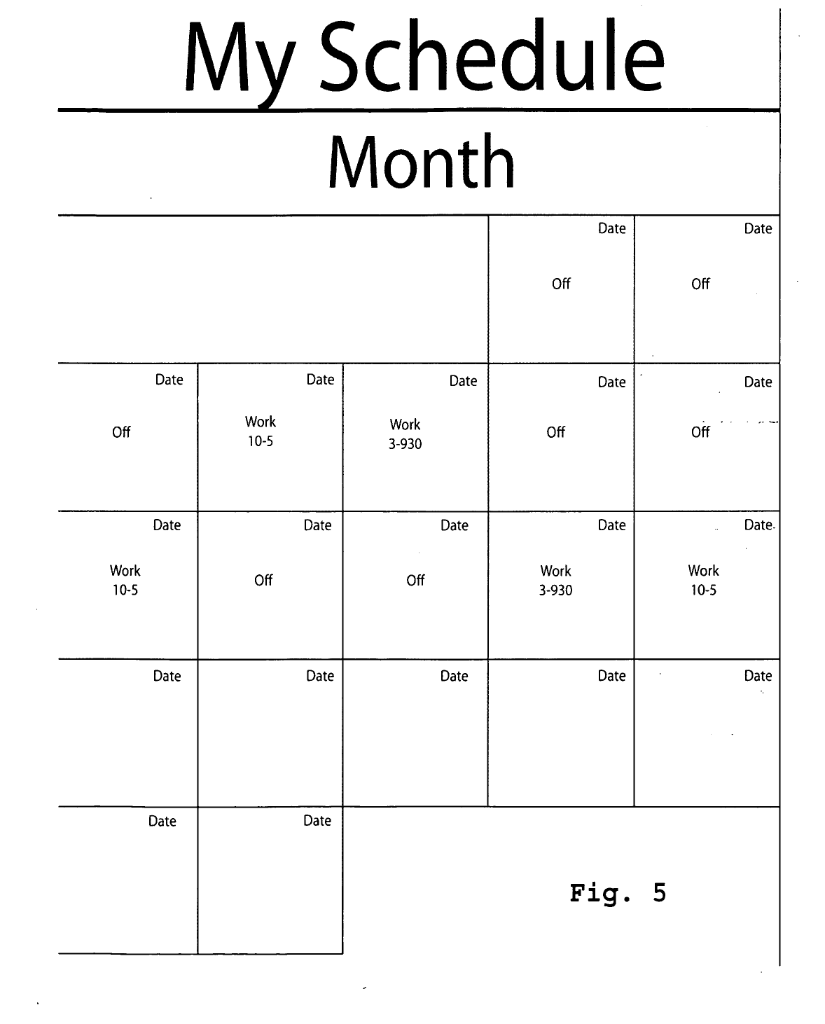

Referring to FIG. 5, this depicts Schedule Page. The “My Schedule” page is a simple uneditable calendar with no fields to enter information. The page shows month at the top and a date in every box. Unscheduled days are left blank until the schedule is inputted by a manager. Different colors and/or shades of gray would be used in the schedule to distinguish days previously worked, future scheduled work shifts, and off days.

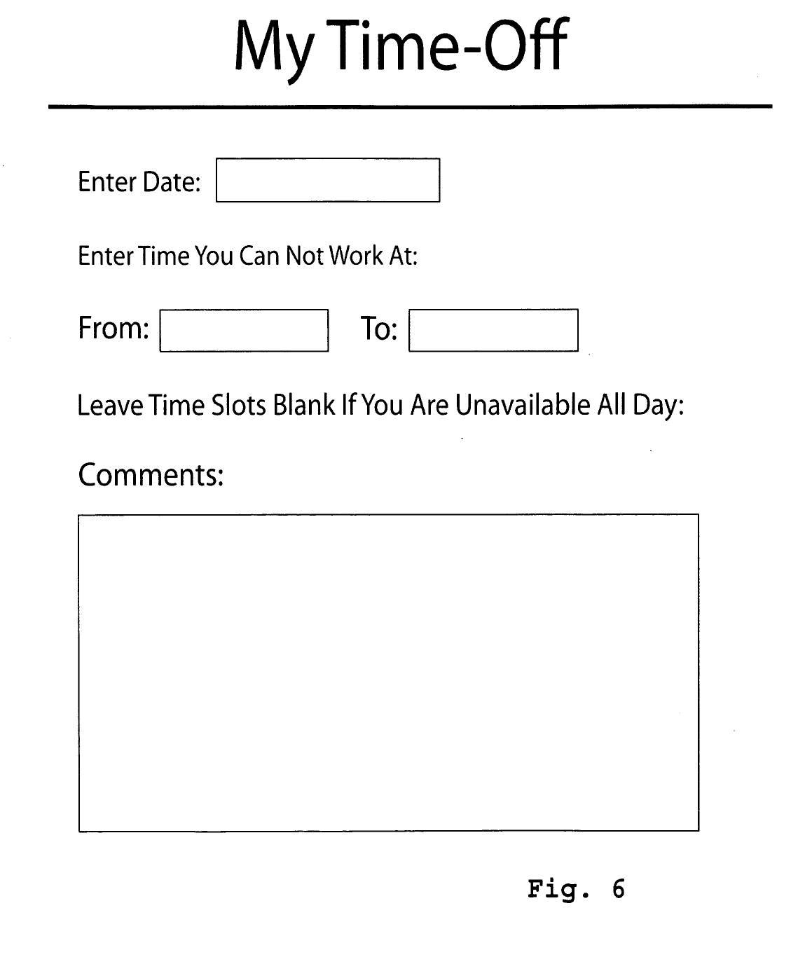

Referring to FIG. 6, this depicts the Time-Off Page. This page allows an employee to notify their employer if they are unable to work an unscheduled shift that they would normally be available to work. Alternately, this page can be “My Availability,” allowing the employee to change their permanent future scheduling (for example, off on all Sundays). This form would be sent to a manager or supervisor in the form of a message, and the decision that they make would be sent to the employee in the form of a message.

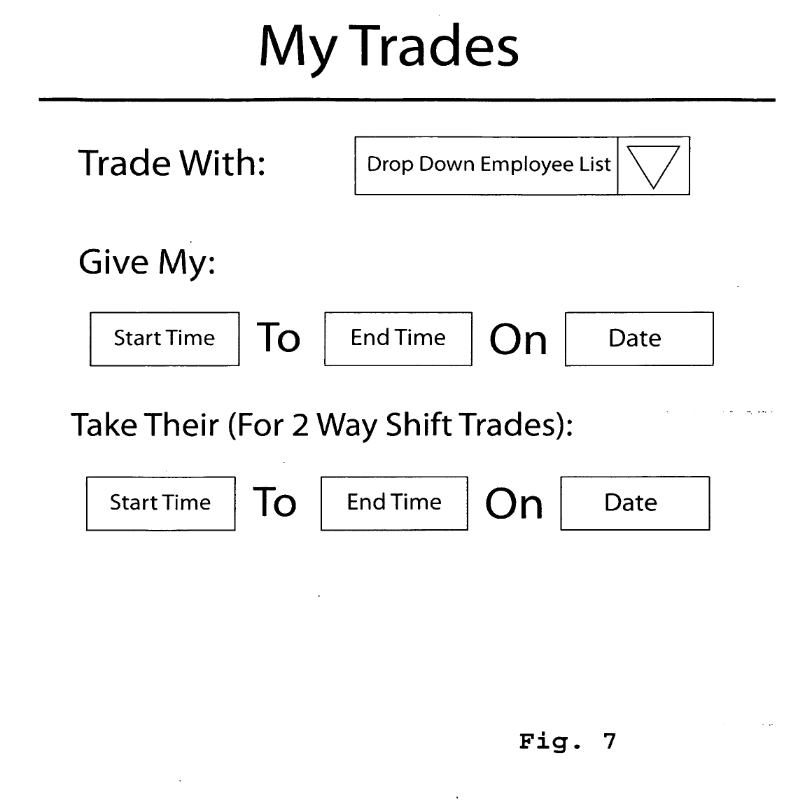

Referring to FIG. 7, this depicts the Trades Page. This page allows employees to give or trade already scheduled shifts to other employees. The drop-down box contains the employees that work in the user's department, i.e., people who can take the shift.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A mobile application software designed to run on one or more mobile operating systems for use by multiple employees of a business, comprising:
a login page that appears when the application is opened, wherein a user employee using the application is required to identify him/herself by entering a pre-assigned employee number and a pre-selected password, and wherein the user employee is authenticated based on his/her entry of a valid employee number and password;
a main page that appears once the user employee is authenticated by the login page, wherein the user employee is able to select from a menu of multiple task options, and wherein the task options available to the user employee on the menu include viewing and sending of messages, viewing of work schedules, designation of dates and/or times when the user employee is not available for work, and arranging of trades of work shifts with other employees; and
wherein each of the task options, when selected by the user employee from the menu of the main page, opens a separate task page from which the selected task option can be performed by the user employee.

2. The mobile application of claim 1, wherein the task pages include a message page, on which the user employee can send messages to and receive messages from other employees of the business and reply to received messages.

3. The mobile application of claim 1, wherein the task pages include a schedule page, which displays scheduled work days and times and scheduled time-off work of the user employee.

4. The mobile application of claim 1, wherein the task pages include a time-off page, on which the user employee can designate certain days and times when he/she is unavailable for work.

5. The mobile application of claim 1, wherein the task pages include a trades page, on which the user employee can arrange to trade work days and/or work shifts with another employee.
